(19) United States
(12) Patent Application Publication
(10) Pub. No.: US 2005/0109853 A1
(43) Pub. Date: May 26, 2005

(54) Print-circuit board forming method and print-circuit board

(75) Inventor: Satoshi Torii, Takefu-shi (JP)

Correspondence Address: REED SMITH LLP, Suite 1400, 3110 Fairview Park Drive, Falls Church, VA, 22042, US

(73) Assignee: Orion Electric Company Ltd.

(21) Appl. No.: 10/986,928

(22) Filed: Nov. 15, 2004

(30) Foreign Application Priority Data
Nov. 20, 2003 (JP) 2003-390222

(51) Int. Cl. G06K 19/06

(52) U.S. Cl. 235/494

(57) ABSTRACT

It is an object to form different identifying marks without using a lot of pattern forming plates for forming identifying marks, while forming identifying marks on print-circuit boards.

A print-circuit board 5 which has a conductor layer 2 and a resist layer 3 is formed by the first step of forming patterns composing identifying marks on the conductor layer 2 and the second step of forming patterns composing identifying marks on the resist layer 3. At the first step, the patterns having patterns 2a and 2b are formed on the conductor layer 2. At the second step, the patterns having patterns 3a, 3b, 3c and 3d are formed on the resist layer 3. The patterns 2a and 3a and the patterns 2b and 3c compose one identifying mark for identifying the print-circuit board 5. Another patterns 3b and 3d are also formed on the resist layer. The patterns 3b and 3d are formed as patterns for composing the other identifying mark.

### BACKGROUND OF THE INVENTION

1. Field of the Invention

The present invention relates to a print-circuit board forming method, and a print-circuit board on which information for identifying a type and the like of the print-circuit board is displayed.

2. Description of the Related Art

Print-circuit boards are used as boards on which electronic parts composing electronic circuits of electric devices such as television and video device are packaged. The print-circuit boards include an insulating layer made of an insulator, a conductor layer for forming a conductor pattern, and a resist layer which is provided on the conductor layer and exposes a part of the conductor layer so as to cover the other part.

An identifying mark for displaying various information relating to the print-circuit boards are formed on the print-circuit boards. Different identifying marks are formed on different print-circuit boards, respectively.

Therefore, the types and the like of the print-circuit boards can be identified by identifying the patterns of the identifying marks. When, for example, electronic parts are packaged on the print-circuit boards by using a chip part packaging machine, the chip part packaging machine identifies an identifying mark using an optical type mark sensor. As a result, the chip part packaging machine recognizes various information relating to the print-circuit board, and packages the electronic parts under suitable packaging conditions.

When different print-circuit boards are mixed by-accident in a production plant, the chip part packaging machine discriminates a difference of identifying marks using the optical type mark sensor, so that the mixing of the different print-circuit boards can be detected.

FIGS. 8A to 9 are diagrams illustrating print-circuit boards on which identifying marks are formed. FIGS. 8A and 8B are plan views showing the state that the print-circuit boards are viewed from top. FIG. 8A is the diagram illustrating a print-circuit board 25 on which one identifying mark is formed by marks P1 and P2. FIG. 8B is the diagram illustrating another print-circuit board 26 on which the other identifying mark is formed by marks P1 and P3.

FIG. 9 is the diagram illustrating a constitution of a portion of the print-circuit boards 25 and 26 on which the mark P1 composing the identifying mark is formed, and is a vertical sectional view along an up-down direction of the portion on which the mark P1 is formed.

As shown in FIG. 9, the print-circuit boards 25 and 26 include an insulating substrate layer 21 composed of an insulating substrate, a conductor layer 22 laminated on the insulating substrate layer 21, and a resist layer 23 laminated on the conductor layer 22.

As shown in FIG. 9, the pattern composing the identifying mark includes a pattern on the conductor layer 22 formed by removing a part of the conductor layer 22 and allowing the conductor portion to partially remain, and a pattern on the resist layer 23 formed by removing a part of the resist layer.

When the identifying mark is formed, the pattern formed by removing the resist of the resist layer 23 and the conductor pattern formed by allowing the conductor portion of a part of the conductor layer to remain are formed in a manner that their positions correspond to a predetermined position on a plane of the print-circuit board.

As a result, the identifying mark can be recognized by viewing the print-circuit board from the top. One identifying mark shown in FIG. 8A and the other identifying mark shown in FIG. 8B are different from each other, and the print-circuit board is identified by these identifying marks.

As a method of forming the identifying marks on the print-circuit boards, various methods are conventionally known (for example, see Japanese Patent Application Laid-Open Nos. 6-69615 and 9-116243).

In order to form identifying marks, patterns should be formed respectively on the conductor layer and the resist layer, as shown above. At the conventional step of forming the identifying marks, according to different identifying marks, different patterns are formed for different identifying marks on both the conductor layer and the resist layer respectively.

At the conventional step of forming the identifying marks, therefore, patterns should be formed on both the conductor layer and the resist layer respectively according to different identifying marks. As a result, respective plates for forming the patterns to be formed on the conductor layer and the resist layer are required.

In order to form the identifying mark, therefore, a lot of pattern forming plates are required for individual identifying marks, and a troublesome work for manufacturing the pattern forming plates is required.

In recent years, eco-friendly materials are being used for electronic devices, and thus materials which do not contain toxic substances are being used for the print-circuit boards. For the print-circuit boards with long product-life, there are some cases where the conventional materials are replaced with materials which do not contain toxic substances to be used for further producing the print-circuit boards which have been produced by conventional.

For this reason, in order to form different identifying marks for print-circuit boards whose outer shape, arrangement of conductor pattern, and arrangement of parts are not changed but use different materials, it is necessary to newly produce plates for printing a conductor layer and a resist layer. This causes a rise in the manufacturing cost of the print-circuit boards.

### SUMMARY OF THE INVENTION

It is an object of the present invention to provide a print-circuit board forming method which is capable of forming identifying marks on a print-circuit board without requiring a lot of pattern forming plates for forming identifying marks on the print-circuit board, and a print-circuit board which is formed by the method.

In order to solve the above problem, the present invention is a print-circuit board forming method, the print-circuit board having an insulating substrate layer, a conductor layer and a resist layer, the conductor layer being laminated on the insulating substrate layer, the resist layer being laminated on the conductor layer, the print-circuit board having identifying marks for identifying the print-circuit board formed by patterns formed on the conductor layer and patterns formed on the resist layer, the method including: the first step of forming the patterns for forming an identifying mark on the conductor layer; and the second step of forming patterns for forming an identifying mark on the resist layer, wherein the patterns for forming one identifying mark are formed on the conductor layer at the first step, and the patterns for forming one identifying mark and the patterns for forming the other identifying mark are formed on the resist layer at the second step, when the patterns for forming the other identifying mark are formed on the resist layer at the second step, the other identifying mark is formed in a manner that its position corresponds to a predetermined position of the patterns to be formed for the other identifying mark on the conductor layer, the patterns for composing one identifying mark to be formed on the conductor layer at the first step and the patterns for composing one identifying mark to be formed on the resist layer at the second step are formed in a manner that their positions correspond to a predetermined position on a plane of the print-circuit board, so that one identifying mark is formed.

According to the invention, not only the patterns forming one identifying mark but also the patterns forming the other identifying mark are formed on the resist layer of one print-circuit board. As a result, when the patterns composing the identifying mark are formed on the resist layer of the print-circuit board, different patterns for different identifying marks do not have to be formed. The patterns on the resist layer for composing one identifying mark and the other identifying mark can be used for a plurality of identifying marks.

When the identifying mark to be formed on the print-circuit board is changed from one identifying mark into the other identifying mark, only the patterns on the conductor layer can be changed without changing the patterns on the resist layer. As a result, a pattern forming plate for forming the patterns composing the identifying marks on the resist layer of the print-circuit board does not have to be adjusted for each identifying mark.

According to the invention, a print-circuit board, which has an insulating substrate layer, a conductor layer and a resist layer and is constituted so that the conductor layer is laminated on the insulating substrate layer and the resist layer is laminated on the conductor layer, can be obtained. In the print-circuit board, the print-circuit board has identifying marks for identifying the print-circuit board formed by patterns formed on the conductor layer and patterns formed on the resist layer, the patterns for forming one identifying mark are formed on the conductor layer, the patterns for forming one identifying mark and the patterns for forming the other identifying mark are formed on the resist layer, the patterns for forming the other identifying mark to be formed on the resist layer are formed in a manner that their position corresponds to a predetermined position of the patterns on the conductor layer to be formed on the conductor layer while forming the other identifying mark, the patterns for composing one identifying mark formed on the conductor layer and the patterns for composing one identifying mark formed on the resist layer are formed in a manner that their positions correspond to a predetermined position on a plane of the print-circuit board, so that one identifying mark is formed.

Further, the invention is a print-circuit board forming method, the print-circuit board having an insulating substrate layer, a conductor layer and a resist layer, the conductor layer being laminated on the insulating substrate layer, the resist layer being laminated on the conductor layer, the print-circuit board having identifying marks for identifying the print-circuit board formed by patterns formed on the conductor layer and patterns formed on the resist layer, the method including: the first step of forming the patterns for forming an identifying mark on the conductor layer; and the second step of forming patterns for forming an identifying mark on the resist layer, wherein the patterns for forming one identifying mark and the patterns for forming the other identifying mark are formed on the conductor layer at the first step, and the patterns for forming one identifying mark are formed on the resist layer at the second step, when the patterns for forming the other identifying mark are formed on the conductor layer at the first step, the other identifying mark is formed in a manner that its position corresponds to a predetermined position of the patterns to be formed on the resist layer while forming the other identifying mark, the patterns for composing one identifying mark to be formed on the conductor layer at the first step and the patterns for composing one identifying mark to be formed on the resist layer at the second step are formed in a manner that their positions correspond to a predetermined position of a plane of the print-circuit board, so that one identifying mark is formed.

According to the invention, not only the patterns forming one identifying mark but also the patterns forming the other identifying mark are formed on the conductor layer of one print-circuit board. As a result, when the patterns composing the identifying mark are formed on the conductor layer of the print-circuit board, different patterns for different identifying marks do not have to be formed. The patterns on the conductor layer formed with the patterns for composing one identifying mark and the other identifying mark can be used for a plurality of identifying marks.

When the identifying mark to be formed on the print-circuit board is changed from one identifying mark into the other identifying mark, only the patterns on the resist layer can be changed without changing the patterns on the conductor layer. As a result, a pattern forming plate for forming the patterns composing the identifying marks on the conductor layer of the print-circuit board does not have to be adjusted for each identifying mark.

According to the invention, a print-circuit board, which has an insulating substrate layer, a conductor layer and a resist layer and is constituted so that the conductor layer is laminated on the insulating substrate layer and the resist layer is laminated on the conductor layer, can be obtained. In the print-circuit board, the print-circuit board has identifying marks for identifying the print-circuit board formed by patterns formed on the conductor layer and patterns formed on the resist layer, the patterns for forming one identifying mark and the patterns for forming the other identifying mark are formed on the conductor layer, the patterns for forming one identifying mark are formed on the resist layer, the patterns for forming the other identifying mark to be formed on the conductor layer are formed in a manner that their position corresponds to a predetermined position of the patterns on the resist layer to be formed on the resist layer while forming the other identifying mark, the patterns for composing one identifying mark formed on the conductor layer and the patterns for composing one identifying mark formed on the resist layer are formed in a manner that their positions correspond to a predetermined position on a plane of the print-circuit board, so that one identifying mark is formed.

Further, the invention is a print-circuit board forming method, the print-circuit board having an insulating substrate layer, a conductor layer and a resist layer, the conductor layer being laminated on the insulating substrate layer, the resist layer being laminated on the conductor layer, the print-circuit board having identifying marks for identifying the print-circuit board formed by patterns formed on the conductor layer and patterns formed on the resist layer, the method including: the first step of forming the patterns for forming an identifying mark on the conductor layer; and the second step of forming the patterns for forming an identifying mark on the resist layer, wherein the patterns for forming one identifying mark and patterns for forming the other identifying mark are formed on the conductor layer at the first step, and the patterns for forming one identifying mark and the patterns for forming the other identifying mark are formed on the resist layer at the second step, the patterns for composing one identifying mark to be formed on the conductor layer at the first step and the patterns for composing one identifying mark to be formed on the resist layer at the second step are formed in a manner that their positions correspond to a predetermined position on a plane of the print-circuit board, so that one identifying mark is formed, the patterns for composing the other identifying mark to be formed on the conductor layer at the first step and the patterns for composing the other identifying mark to be formed on the resist layer at the second step are formed in a manner that their positions correspond to a predetermined position on a plane of the print-circuit board, and the print-circuit board forming method further comprising the third step of printing a shielding material on portions of the patterns for composing the other identifying mark on the conductor layer and the resist layer so as to shield the other identifying mark.

According to the invention, not only the patterns forming one identifying mark but also the patterns forming the other identifying mark are formed on the conductor layer of one print-circuit board. The patterns forming one identifying mark and also the patterns forming the other identifying mark are formed on the resist layer.

As a result, when the patterns composing the identifying marks are formed on the conductor layer and the resist layer of the print-circuit board, different patterns for different identifying marks do not have to be formed.

The patterns on the conductor layer for composing one identifying mark and the other identifying mark and the patterns on the resist layer for composing one identifying mark and the other identifying mark can be used for a plurality of identifying marks.

When the identifying mark to be formed on the print-circuit board is changed from one identifying mark into the other identifying mark, the change can be coped with printing a shielding material to shield portions of unnecessary identifying marks without changing the patterns on the conductor layer and the resist layer.

As a result, a pattern forming plate for forming the patterns composing the identifying marks on the conductor layer of the print-circuit board, and a pattern forming plate for forming the patterns composing the identifying marks on the resist layer of the print-circuit board do not have to be adjusted for each identifying mark.

According to the invention, a print-circuit board, which has an insulating substrate layer, a conductor layer and a resist layer and is constituted so that the conductor layer is laminated on the insulating substrate layer and the resist layer is laminated on the conductor layer, can be obtained. In the print-circuit board, the print-circuit board has identifying marks for identifying the print-circuit board formed by patterns formed on the conductor layer and patterns formed on the resist layer, the patterns for forming one identifying mark and the patterns for forming the other identifying mark are formed on the conductor layer, the patterns for forming one identifying mark and patterns for forming the other identifying mark are formed on the resist layer, the patterns for composing one identifying mark formed on the conductor layer and the patterns for composing one identifying mark formed on the resist layer are formed in a manner that their positions correspond to a predetermined position on a plane of the print-circuit board, so that one identifying mark is formed, the patterns for composing the other identifying mark formed on the conductor layer and the patterns for composing the other identifying mark formed on the resist layer are formed in a manner that their positions correspond to a predetermined position on the plane of the print-circuit board, and a portion of the patterns for composing the other identifying mark on the conductor layer and a portion of the patterns for composing the other identifying mark on the resist layer are shielded by shielding portions which are formed by printing a shielding material on the portions.

The present invention is carried out in the above-explained forms, and produces the following effects. According to the invention, the identifying marks can be formed on the print-circuit board without requiring a lot of pattern forming plates for forming the identifying marks on the print-circuit board.

As a result, when the print-circuit board formed with the identifying marks is formed, a number of the steps can be reduced, and the manufacturing cost of the print-circuit board can be reduced.

### BRIEF DESCRIPTION OF THE DRAWINGS

FIGS. 1A and 1B are plan views illustrating print-circuit boards obtained by a first embodiment of the present invention;

FIG. 2 is a vertical sectional view illustrating the print-circuit board shown in FIGS. 1A and 1B;

FIGS. 3A and 3B are plan views illustrating print-circuit boards obtained by a second embodiment of the present invention;

FIG. 4 is a vertical sectional view illustrating the print-circuit board shown in FIGS. 3A and 3B;

FIGS. 5A and 5B are plan views illustrating print-circuit boards obtained by a third embodiment of the present invention;

FIG. 6 is a vertical sectional view illustrating the print-circuit board shown in FIGS. 5A and 5B;

FIGS. 7A to 7D are diagrams illustrating examples of the print-circuit board in which a shielding material is printed so that the other identifying mark is shielded;

FIGS. 8A and 8B are diagrams illustrating the print-circuit boards on which conventional identifying marks are formed; and

FIG. 9 is a sectional view illustrating the print-circuit board shown in FIGS. 8A and 8B.

### DESCRIPTION OF THE PREFERRED EMBODIMENTS

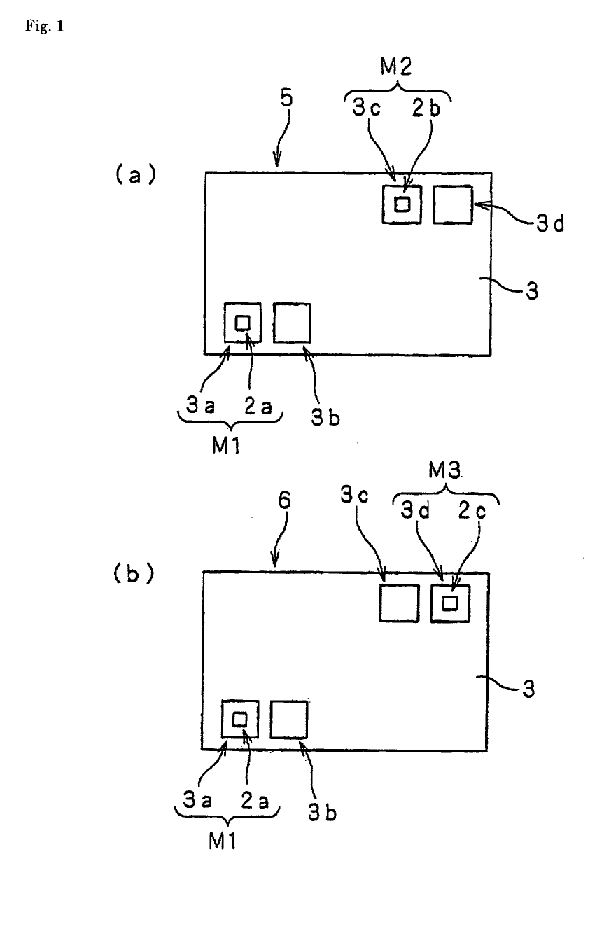

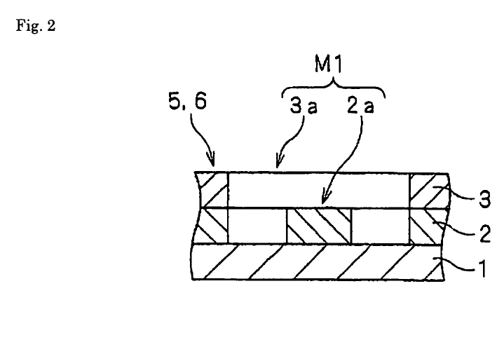

Embodiments of the present invention are explained below with reference to FIGS. 1A to 7D. A first embodiment of the present invention is explained with reference to FIGS. 1A to 2. FIGS. 1A to 2 are diagrams illustrating a print-circuit board obtained by the first embodiment of the present invention.

FIG. 1A shows one example of the print-circuit board obtained by the first embodiment of the present invention, and is a plan view illustrating a state that a print-circuit board 5 on which first identifying marks (M1 and M2) are formed is viewed from top.

FIG. 1B shows another example of the print-circuit board obtained by the first embodiment of the present invention, and is a plan view illustrating a state that a print-circuit board 6 on which second identifying marks (M1 and M3) are formed is viewed from top.

A second mark M2 is formed on the print-circuit board 5 shown in FIG. 1A, and a third mark M3 is formed on the print-circuit board 6 shown in FIG. 1B. Except for this, the print-circuit boards 5 and 6 are formed as to have the same dimension and constitution of the layers.

FIG. 2 is a vertical sectional view illustrating a section along an up-down direction of the print-circuit boards 5 and 6 shown in FIGS. 1A and 1B, and are vertical sectional view illustrating a portion where patterns for composing identifying marks on the print-circuit board 5 and 6 are formed. FIG. 2 shows an example of the first mark M1 on the section composing the identifying mark.

As shown in FIG. 1A, the first mark M1 and the second mark M2 are formed on the print-circuit board 5 by patterns formed on a conductor layer 2, and patterns formed on a resist layer 3, explained below. The first mark M1 and the second mark M2 compose a first identifying mark on the print-circuit board 5.

As shown in FIG. 1B, the first mark M1 and the third mark M3 are formed on the print-circuit board 6 by patterns formed on the conductor layer 2 and patterns formed on the resist layer 3, mentioned later. The first mark M1 and the third Mark M3 compose a second identifying mark on the print-circuit board 6.

As shown in FIG. 2, the print-circuit boards 5 and 6 include an insulating substrate layer 1, the conductor layer 2, and the resist layer 3. As shown in FIG. 2, the conductor layer 2 is laminated on an upper side of the insulating substrate layer 1, and the resist layer 3 is laminated on an upper side of the conductor layer 2.

The insulating substrate layer 1 is constituted by an insulating substrate. Examples of the insulating substrate composing the insulating substrate layer 1 are substrates and the like made of paper base phenol resin, paper base epoxy resin, and glass cloth base epoxy resin.

The conductor layer 2 is constituted by a conductor. The conductor layer 2 can be formed by a layer made of copper foil. A circuit pattern, not shown, for configuring a part of an electric circuit of an electric device to which this print-circuit board is packaged is formed on the conductor layer 2.

Further, patterns for forming an identifying mark are formed on the conductor layer 2. Patterns 2a and 2b are formed on the print-circuit board 5. Patterns 2a and 2c are formed on the print-circuit board 6. The patterns on the conductor layer 2 for forming the identifying mark are formed by removing a part of the conductor layer 2 and allowing a part of the conductor portion to remain.

At the step of forming the patterns for forming the identifying mark on the conductor layer 2, an unnecessary portion of the conductor layer 2 is removed and a necessary conductor portion is allowed to remain by etching. The step of forming the pattern for composing the identifying mark on the conductor layer 2 corresponds to the first step.

The resist layer 3 can be formed by resist ink. The resist layer 3 is provided so that a part of the conductor layer 2 on its lower side is exposed and cover the other portion.

In both the print-circuit boards 5 and 6, patterns 3a, 3b, 3c and 3d for forming the identifying mark are formed on the resist layer 3. The patterns 3a, 3b, 3c and 3d are formed by removing corresponding portions of the resist layer 3 for forming the identifying mark.

At the step of forming the patterns composing the identifying mark on the resist layer 3, required portions of the resist layer 3c an be removed by screen (plate making) printing. The step of forming the patterns for composing the identifying mark on the resist layer 3 corresponds to the second step.

In the print-circuit board 5, the patterns on the conductor layer 2 and the patterns on the resist layer 3 for composing the first identifying mark are formed in a manner that their positions correspond to a predetermined position on a plane of the print-circuit board 5. That is to say, as shown in FIG. 1A, in the print-circuit board 5, the patterns 2a and 3a are formed in a manner that their positions correspond to a predetermined position on the plane of the print-circuit board 5, and the patterns 2b and 3c are formed in a manner that their positions correspond to a predetermined position on the plane of the print-circuit board 5.

As a result, when the print-circuit board 5 is viewed from the top, as shown in FIG. 1A, the pattern 2a of the conductor layer 2 can be recognized through the pattern 3a of the resist layer 3, and the pattern 2b of the conductor layer 2 can be recognized through the pattern 3c of the resist layer 3.

On the print-circuit board 5, the first mark M1 is formed by the patterns 2a and 3a, and the second mark M2 is formed by the patterns 2b and 3c. On the print-circuit board 5, the first identifying mark is constituted by the first and the second marks, M1 and M2. The first identifying mark can be identified from the top on the print-circuit board 5.

On the print-circuit board 6, the patterns on the conductor layer 2 and the patterns on the resist layer 3 for composing the second identifying mark are formed in a manner that their positions correspond to a predetermined position on the plane of the print-circuit board 6. That is to say, as shown in FIG. 1B, on the print-circuit board 6, the patterns 2a and 3a are formed in a manner that their positions correspond to a predetermined position on the plane of the print-circuit board 6, and patterns 2c and 3d are formed in a manner that their positions correspond to a predetermined position on the plane of the print-circuit board 6.

As a result, when the print-circuit board 6 is viewed from the top, as shown in FIG. 1B, the pattern 2a of the conductor layer 2 can be recognized through the pattern 3a of the resist layer 3, and the pattern 2c of the conductor layer 2 can be recognized through the pattern 3d of the resist layer 3.

On the print-circuit board 6, the first mark M1 is formed by the patterns 2a and 3a, and the third mark M3 is formed by the patterns 2c and 3d. On the print-circuit board 6, the second identifying mark is constituted by the first and the third marks M1 and M3. The second identifying mark can be identified from the top on the print-circuit board 6.

As shown in FIG. 1A, on the print-circuit board 5, the patterns 3b and 3d are formed on the resist layer 3. The patterns 3b and 3d do not compose the first identifying mark on the print-circuit board 5.

The patterns 3b and 3d on the print-circuit board 5 are formed so as to compose the other identifying mark other than the first identifying mark. For example, the pattern 3d on the print-circuit board 5 can compose the third mark M3 formed on the print-circuit board 6.

As shown in FIG. 1B, on the print-circuit board 6, the patterns 3b and 3c are formed on the resist layer 3. The patterns 3b and 3c do not compose the second identifying mark on the print-circuit board 6.

The patterns 3b and 3c on the print-circuit board 6 can compose the other identifying mark other than the second identifying mark. For example, the pattern 3c on the print-circuit board 6 can compose the second mark M2 to be formed on the print-circuit board 5.

On the print-circuit board 5, as shown in FIG. 1A, the mark M1 is formed on one of the four corners of the print-circuit board 5, and the mark M2 is formed in a position which is on a slightly inner side of another corner. The marks M1 and M2 are formed so as to be approximately positioned on a diagonal line for connecting the corners formed with the marks.

On the print-circuit board 6, as shown in FIG. 1B, the mark M1 is formed on one of the four corners of the print-circuit board 6, and the mark M3 is formed on another corner. The marks M1 and M3 are formed so as to be positioned on a diagonal line for connecting the corners formed with the marks.

On the print-circuit board 5, various information relating to the print-circuit board 5 can be identified by the first identifying mark. On the print-circuit board 6, various information relating to the print-circuit board 6 can be identified by the second identifying mark.

The information about the print-circuit boards represented by the identifying marks includes insulating materials to be used for the insulating substrate layers of the print-circuit boards, and materials of solder to be used for the case where electronic parts are packaged to the print-circuit boards.

The first embodiment of the present invention has the following advantage. On the print-circuit board 5, for example, not only the patterns 3a and 3c for forming the first identifying mark but also the patterns 3b and 3d for forming the other identifying mark are formed on the resist layer 3 at the second step.

On the print-circuit board 6, not only the patterns 3a and 3d for forming the second identifying mark but also the patterns 3b and 3c for forming the other identifying mark are formed on the resist layer 3 at the second step.

According to the first embodiment of the invention, not only patterns for forming one identifying mark but also patterns for forming the other identifying mark are formed on the resist layer of one print-circuit board.

As a result, when the patterns composing the identifying mark are formed on the resist layer of the print-circuit board, different patterns for different identifying marks do not have to be formed, and thus patterns on the resist layer formed with the patterns for composing one identifying mark and the other identifying mark can be used for a plurality of identifying marks.

When different identifying marks are formed, only patterns on the conductor layer can be changed without changing the patterns on the resist layer. As a result, a plate, which is used for forming patterns composing an identifying mark on the resist layer of the print-circuit board, does not have to be adjusted for each identifying mark.

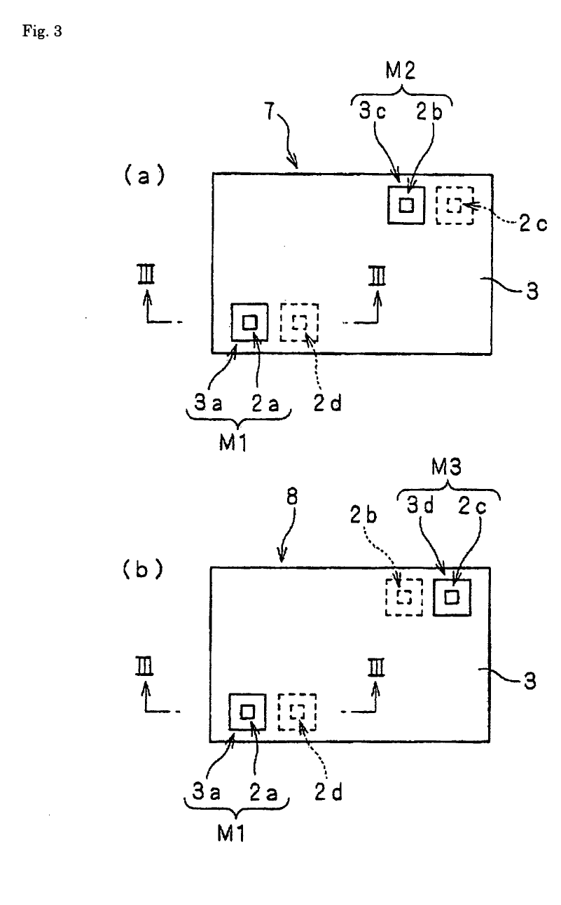

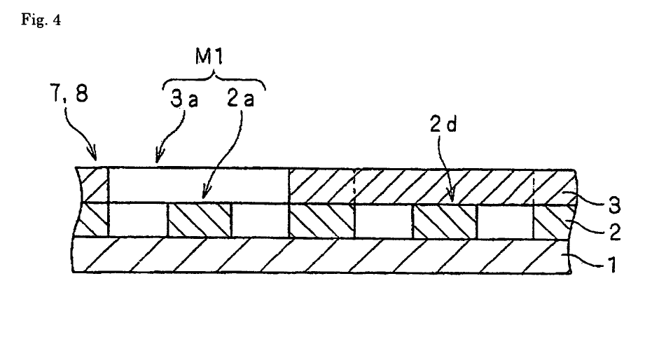

A second embodiment of the present invention is explained below with reference to FIGS. 3A to 4. FIGS. 3A to 4 are diagrams illustrating print-circuit boards obtained by the second embodiment of the invention.

FIG. 3A shows one example of the print-circuit board obtained by the second embodiment of the present invention, and is a plan view illustrating a state that a print-circuit board 7 on which first identifying marks (M1 and M2) are formed is viewed from top.

FIG. 3B shows another example of the print-circuit board obtained by the second embodiment of the present invention, and is a plan view illustrating a state that a print-circuit board 8 on which second identifying marks (M1 and M3) are formed is viewed from top.

A second mark M2 is formed on the print-circuit board 7 shown in FIG. 3A, and a third mark M3 is formed on the print-circuit board 8 shown in FIG. 3B. Except for this, the print-circuit boards 7 and 8 are formed as to have the same dimension and constitution of the layers.

FIG. 4 is a vertical sectional view taken along line III-III of FIGS. 3A and 3B. FIG. 4 shows a vertical section along an up-down direction of a portion on the print-circuit board where the first mark M1 is formed. With reference to the example shown in FIG. 4, sections of the portions on the print-circuit boards 7 and 8 where patterns for composing the identifying mark are formed can be understood.

As shown in FIG. 3A, the first mark M1 and the second mark M2 are formed on the print-circuit board 7. The first mark Ml and the second mark M2 compose the first identifying mark on the print-circuit board 7.

As shown in FIG. 3B, the first mark M1 and the third mark M3 are formed on the print-circuit board 8. The first mark M1 and the third Mark M3 compose the second identifying mark on the print-circuit board 8.

As shown in FIG. 4, the print-circuit boards 7 and 8 include an insulating substrate layer 1, a conductor layer 2, and a resist layer 3. The conductor layer 2 is laminated on an upper side of the insulating substrate layer 1, and the resist layer 3 is laminated on an upper side of the conductor layer 2.

Materials composing the insulating substrate layer 1, the conductor layer 2 and the resist layer 3 are similar to those of the print-circuit boards 5 and 6. As shown in FIGS. 3A and 4, the patterns 2a, 2b, 2c and 2d for composing the identifying marks are formed on the conductor layer 2 of the print-circuit board 7. As shown in FIGS. 3B and 4, the patterns 2a, 2b, 2c and 2d for composing the identifying marks are formed on the print-circuit board 8 as well.

Similarly to the explanation of the print-circuit boards 5 and 6, at the step of forming the patterns composing the identifying mark on the conductor layer 2, the patterns can be formed by etching. The step of forming the patterns for composing the identifying marks on the conductor layer 2 corresponds to the first step.

As shown in FIG. 3A, the patterns 3a and 3c for composing the first identifying mark are formed on the resist layer 3 of the print-circuit board 7. On the other hand, as shown in FIG. 3B, the patterns 3a and 3d for composing the second identifying mark are formed on the resist layer 3 of the print-circuit board 8.

At the step of forming the patterns composing the identifying marks in the resist layer 3, similarly to the explanation of the print-circuit boards 5 and 6, the patterns can be formed by screen (plate making) printing. The step of forming the patterns for composing the identifying mark on the resist layer 3 corresponds to the second step.

On the print-circuit board 7, the patterns on the conductor layer 2 and the patterns on the resist layer 3 for composing the first identifying mark are formed in a manner that their positions correspond to a predetermined position on the plane of the print-circuit board 7. That is to say, as shown in FIG. 3A, in the print-circuit board 7, the patterns 2a and 3a are formed in a manner that their positions correspond to a predetermined position on the plane of the print-circuit board 7, and the patterns 2b and 3c are formed in a manner that their positions correspond to a predetermined position on the plane of the print-circuit board 7.

As a result, when the print-circuit board 7 is viewed from the top, as shown in FIG. 3A, the pattern 2a of the conductor layer 2 can be recognized through the pattern 3a of the resist layer 3, and the pattern 2b of the conductor layer 2 can be recognized through the pattern 3c of the resist layer 3.

On the print-circuit board 7, the first mark M1 is formed by the patterns 2a and 3a, and the second mark M2 is formed by the patterns 2b and 3c. On the print-circuit board 7, the first identifying mark is constituted by the first and the second marks M1 and M2. The first identifying mark can be identified from the top on the print-circuit board 7.

On the print-circuit board 8, the pattern on the conductor layer 2 and the pattern on the resist layer 3 for composing the second identifying mark are formed in a manner that their positions correspond to a predetermined position on the plane of the print-circuit board 8. That is to say, as shown in FIG. 3B, on the print-circuit board 8, the patterns 2a and 3a are formed in a manner that their positions correspond to a predetermined position on the plane of the print-circuit board 8, and the patterns 2c and 3d are formed in a manner that their positions correspond to a predetermined position on the plane of the print-circuit board 8.

As a result, when the print-circuit board 8 is viewed from the top, as shown in FIG. 3B, the pattern 2a of the conductor layer 2 can be recognized through the pattern 3a of the resist layer 3, and the pattern 2c of the conductor layer 2 can be recognized through the pattern 3d of the resist layer 3.

On the print-circuit board 8, the first mark M1 is formed by the patterns 2a and 3a, and the third mark M3 is formed by the patterns 2c and 3d. On the print-circuit board 8, the second identifying mark is constituted by the first and the third marks M1 and M3. The second identifying mark can be identified from the top on the print-circuit board 8.

As shown in FIG. 3A, on the print-circuit board 7, the patterns 2c and 2d are formed in the conductor layer 2. The patterns 2c and 2d do not compose the first identifying mark on the print-circuit board 7.

The patterns 2c and 2d on the print-circuit board 7 are formed so as to compose the other identifying mark other than the first identifying mark. For example, the pattern 2c on the print-circuit board 7 can compose the third mark M3 to be formed on the print-circuit board 8.

As shown in FIG. 3B, on the print-circuit board 8, the patterns 2b and 2d are formed on the conductor layer 2. The patterns 2b and 2d do not compose the second identifying mark on the print-circuit board 8.

The patterns 2b and 2d on the print-circuit board 8 are formed so as to compose the other identifying mark other than the second identifying mark. For example, the pattern 2b on the print-circuit board 8 can compose the second mark M2 to be formed on the print-circuit board 7.

On the print-circuit board 7, as shown in FIG. 3A, the mark M1 is formed on one of the four corners of the print-circuit board 7, and the mark M2 is formed in a position which is on a slightly inner side of another corner. The marks M1 and M2 are formed so as to be approximately positioned on a diagonal line for connecting the corners formed with the marks.

On the print-circuit board 8, as shown in FIG. 3B, the mark M1 is formed on one of the four corners of the print-circuit board 8, and the mark M3 is formed on another corner. The marks M1 and M3 are formed so as to be positioned on a diagonal line for connecting the corners formed with the marks.

On the print-circuit board 7, various information relating to the print-circuit board 7 can be identified by the first identifying mark. On the print-circuit board 8, various information relating to the print-circuit board 8 can be identified by the second identifying mark.

The second embodiment of the present invention has the following advantage. On the print-circuit board 7, for example, not only the patterns 2a and 2b for forming the first identifying mark but also the patterns 2c and 2d for forming the other identifying mark are formed on the conductor layer 2 at the first step.

On the print-circuit board 8, not only the patterns 2a and 2c for forming the second identifying mark but also the patterns 2b and 2d for forming the other identifying mark are formed on the conductor layer 2 at the first step.

According to the second embodiment of the invention, not only patterns for forming one identifying mark but also patterns for forming the other identifying mark are formed on the conductor layer of one print-circuit board.

As a result, when the patterns composing the identifying mark are formed on the conductor layer of the print-circuit board, different patterns for different identifying marks do not have to be formed, and thus patterns on the conductor layer formed with the patterns for composing one identifying mark and the other identifying mark can be used for a plurality of identifying marks.

When different identifying marks are formed, only patterns on the resist layer can be changed without changing the patterns on the conductor layer. As a result, a plate, which is used for forming patterns composing an identifying mark on the conductor layer of the print-circuit board, does not have to be adjusted for each identifying mark.

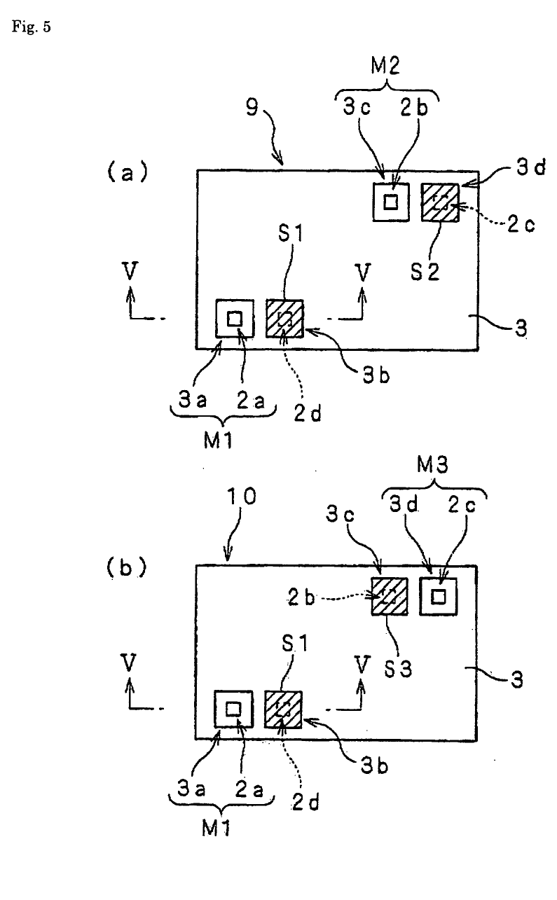

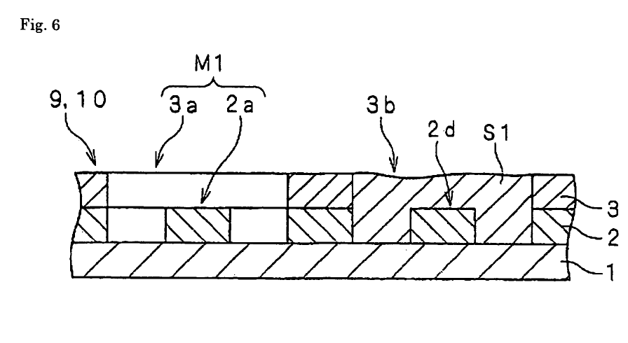

A third embodiment of the present invention is explained below with reference to FIGS. 5A to 6. FIGS. 5A to 6 are diagrams illustrating print-circuit boards obtained by the third embodiment of the invention.

FIG. 5A shows one example of the print-circuit board obtained by the third embodiment of the present invention, and is a plan view illustrating a state that a print-circuit board 9 on which first identifying marks (M1 and M2) are formed is viewed from top.

FIG. 5B shows another example of the print-circuit board obtained by the third embodiment of the present invention, and is a plan view illustrating a state that a print-circuit board 10 on which second identifying marks (M1 and M3) are formed is viewed from top. A shielding portion S2 is formed on the print-circuit board 9, and a shielding portion S3 is formed on the print-circuit board 10. Except for this, the print-circuit boards 9 and 10 are formed so as to have the same dimension and the same constitution of the layers.

FIG. 6 is a vertical sectional view taken along line V-V of FIGS. 5A and 5B. FIG. 6 shows a vertical section along an up-down direction of a portion on the print-circuit board where the first mark M1 is formed. With reference to the example shown in FIG. 6, sections of the portions on the print-circuit boards 9 and 10 where patterns for composing the identifying marks are formed can be understood.

As shown in FIG. 5A, a first mark M1 and a second mark M2 are formed on the print-circuit board 9. The first mark M1 and the second mark M2 compose the first identifying mark on the print-circuit board 9.

As shown in FIG. 5B, the first mark M1 and a third mark M3 are formed on the print-circuit board 10. The first mark M1 and the third Mark M3 compose the second identifying mark on the print-circuit board 10.

As shown in FIG. 6, the print-circuit boards 9 and 10 include an insulating substrate layer 1, a conductor layer 2, and a resist layer 3. The conductor layer 2 is laminated on an upper side of the insulating substrate layer 1, and the resist layer 3 is laminated on an upper side of the conductor layer 2.

Materials composing the insulating substrate layer 1, the conductor layer 2 and the resist layer 3 are similar to those of the print-circuit boards 5 and 6. As shown in FIGS. 5A and 6, the patterns 2a, 2b, 2c and 2d for composing the identifying marks are formed on the conductor layer 2 of the print-circuit board 9. As shown in FIGS. 5B and 6, the patterns 2a, 2b, 2c and 2d for composing the identifying marks are formed on the print-circuit board 10 as well.

Similarly to the explanation of the print-circuit boards 5 and 6, at the step of forming the patterns composing the identifying marks on the conductor layer 2, the patterns can be formed by etching. The step of forming the patterns for composing the identifying marks on the conductor layer 2 corresponds to the first step.

As shown in FIG. 5A, the patterns 3a, 3b, 3c and 3d for composing the identifying marks are formed on the resist layer 3 of the print-circuit board 9. As shown in FIG. 5B, the patterns 3a, 3b, 3c and 3d for composing the identifying marks are formed on the resist layer 3 of the print-circuit board 10 as well.

At the step of forming the patterns composing the identifying marks on the resist layer 3, similarly to the explanation of the print-circuit boards 5 and 6, the patterns can be formed by screen (plate making) printing. The step of forming the patterns for composing the identifying marks on the resist layer 3 corresponds to the second step.

On the print-circuit board 9, the patterns on the conductor layer 2 and the patterns on the resist layer 3 for composing the first identifying mark are formed in a manner that their positions correspond to a predetermined position on the plane of the print-circuit board 9. That is to say, as shown in FIG. 5A, on the print-circuit board 9, the patterns 2a and 3a are formed in a manner that their positions correspond to a predetermined position on the plane of the print-circuit board 9, and the patterns 2b and 3c are formed in a manner that their positions correspond to a predetermined position on the plane of the print-circuit board 9.

As a result, when the print-circuit board 9 is viewed from top, as shown in FIG. 5A, the pattern 2a on the conductor layer 2 can be recognized through the pattern 3a on the resist layer 3, and the pattern 2b on the conductor layer 2 can be recognized through the pattern 3c on the resist layer 3.

On the print-circuit board 9, the first mark M1 is formed by the patterns 2a and 3a, and the second mark M2 is formed by the patterns 2b and 3c. On the print-circuit board 9, the first identifying mark is constituted by the first and the second marks, M1 and M2. The first identifying mark can be identified from the top on the print-circuit board 9.

On the print-circuit board 9, as shown in FIG. 5A, the mark M1 is formed on one of the four corners of the print-circuit board 9, and the mark M2 is formed in a position which is on a slightly inner side of another corner.

The marks M1 and M2 are formed so as to be approximately positioned on a diagonal line for connecting the corners formed with the marks. On the print-circuit board 9, various information relating to the print-circuit board 9 is identified by the first identifying mark.

On the print-circuit board 10, the pattern on the conductor layer 2 and the pattern on the resist layer 3 for composing the first identifying mark are formed in a manner that their positions correspond to a predetermined position on the plane of the print-circuit board 10. That is to say, as shown in FIG. 5B, on the print-circuit board 10, the patterns 2a and 3a are formed in a manner that their positions correspond to a predetermined position on the plane of the print-circuit board 10, and patterns 2c and 3d are formed in a manner that their positions correspond to a predetermined position on the plane of the print-circuit board 10.

As a result, when the print-circuit board 10 is viewed from top, as shown in FIG. 5B, the pattern 2a on the conductor layer 2 can be recognized through the pattern 3a on the resist layer 3, and the pattern 2c on the conductor layer 2 can be recognized through the pattern 3d on the resist layer 3.

On the print-circuit board 10, the first mark M1 is formed by the patterns 2a and 3a, and the third mark M3 is formed by the patterns 2c and 3d. On the print-circuit board 10, the second identifying mark is constituted by the first and the third marks, M1 and M3. The second identifying mark can be identified from the top on the print-circuit board 10.

On the print-circuit board 10, as shown in FIG. 5B, the mark M1 is formed on one of the four corners of the print-circuit board 10, and the mark M3 is formed on another corner. The marks M1 and M3 are formed so as to be positioned on a diagonal line for connecting the corners formed with the marks. On the print-circuit board 10, various information relating to the print-circuit board 10 is identified by the second identifying mark.

As shown in FIG. 5A, on the print-circuit board 9, the patterns 2c and 3d are formed in a manner that their positions correspond to a predetermined position on the plane of the print-circuit board 9, and the patterns 2d and 3b are formed in a manner that their positions correspond to a predetermined position on the plane of the print-circuit board 9.

As shown in FIGS. 5A and 6, the shielding portion S1 is formed on a portion of the print-circuit board 9 where the patterns 2d and 3b are formed. Further, as shown in FIG. 5A, the shielding portion S2 is formed on a portion of the print-circuit board 9 where the patterns 2c and 3d are formed.

The shielding portion S1 is formed by printing a silk material as a shielding material on a portion of the conductor layer 2 where a conductor on the portion formed with the pattern 2d is removed and on a portion of the resist layer 3 where the pattern 3b is formed and resist is removed.

The shielding portion S2 is formed by printing a silk material as a shielding material on a portion of the conductor layer 2 where conductor on the portion formed with the pattern 2c is removed and on a portion of the resist layer 3 where the pattern 3d is formed and resist is removed.

By forming the shielding portions S1 and S2, the patterns 2d and 2c formed on the conductor layer 2 of the print-circuit board 9 are shielded. As a result, when the print-circuit board 9 is viewed from the top, the patterns 2d and 2c cannot be identified. As a result, only the first mark M1 and the second mark M2 can be identified on the print-circuit board 9, so that the first identifying mark can be identified.

The patterns 2d and 3b shielded by the shielding portion S1 on the print-circuit board 9, and the patterns 2c and 3d shielded by the shielding portion S2 can compose the other identifying mark other than the first identifying mark. For example, the patterns 2c and 3d on the print-circuit board 9 can compose the third mark M3 to be formed on the print-circuit board 10.

As shown in FIG. 5B, on the print-circuit board 10, the patterns 2b and 3c are formed in a manner that their positions correspond to a predetermined position on the plane of the print-circuit board 10, and the patterns 2d and 3b are formed in a manner that their positions correspond to a predetermined position on the plane of the print-circuit board 10.

As shown in FIGS. 5B and 6, the shielding portion S1 is formed on the portion of the print-circuit board 10 where the patterns 2d and 3b are formed. Further, the shielding portion S3 is formed on the portion of the print-circuit board 10 where the patterns 2b and 3c are formed as shown in FIG. 5B.

The shielding portions S1 and S3 to be formed on the print-circuit board 10 are formed in the similar manner to that of the shielding portions S1 and S2 formed on the print-circuit board 9.

By forming the shielding portions S1 and S3 on the print-circuit board 10, the patterns 2b and 2d formed on the conductor layer 2 of the print-circuit board 10 are shielded. As a result, when the print-circuit board 10 is viewed from the top, the patterns 2b and 2d cannot be identified.

As a result, when the print-circuit board 10 is viewed from the top, only the first mark M1 and the third mark M3 can be identified, so that the second identifying mark can be identified.

The patterns 2d and 3b shielded by the shielding portion S1, and the patterns 2b and 3c shielded by the shielding portion S3 on the print-circuit board 10 can compose the other identifying mark other than the second identifying mark. For example, the patterns 2b and 3c on the print-circuit board 10 can compose the second mark M2 to be formed on the print-circuit board 9.

The shielding portions S1, S2 and S3 are formed in the following manner. A transfer plate for transferring a shielding portion so as to print it on a print-circuit board is prepared. Predetermined positions of the transfer plate are filled with a silk material for forming the shielding portions. The predetermined positions of the transfer plate correspond to the positions on the print-circuit board where the shielding portions are to be provided.

When the transfer plate which is filled with the silk material for forming the shield portions is pressed against the surface of the print-circuit board, the silk material is transferred from the transfer plate to the print-circuit board. As a result, the shielding portions are formed on the print-circuit board by the transferred silk material. The step of printing the shielding material on the print-circuit board so as to form the shielding portions corresponds to the third step.

The print-circuit board forming step includes the silk printing step (or symbol printing step) of generally printing graphics and characters representing symbols, numbers and the like of parts using the silk material. The step of printing the silk material so as to form the shielding portions can be executed as a part of the silk printing step.

The third embodiment of the present invention has the following advantage. On the print-circuit board 9, for example, not only the patterns 2a and 2b for forming the first identifying mark but also the patterns 2c and 2d for forming the other identifying mark are formed on the conductor layer 2 at the first step. On the print-circuit board 9, not only the patterns 3a and 3c for forming the second identifying mark but also the patterns 3b and 3d for forming the other identifying mark are formed on the resist layer 3 at the second step.

On the print-circuit board 10, not only the patterns 2a and 2c for forming the second identifying mark but also the patterns 2b and 2d for forming the other identifying mark are formed on the conductor layer 2 at the first step. Further, on the print-circuit board 10, not only the patterns 3a and 3d for forming the second identifying mark but also the patterns 3b and 3c for forming the other identifying mark are formed on the resist layer 3 at the second step.

According to the third embodiment of the invention, not only patterns for forming one identifying mark but also patterns for forming the other identifying mark are formed on the conductor layer of one print-circuit board. Not only patterns for forming one identifying mark but also patterns for forming the other identifying mark are formed on the resist layer.

As a result, when the patterns composing the identifying marks are formed on the conductor layer and the resist layer of the print-circuit board, different patterns for different identifying marks do not have to be formed.

The patterns of the conductor layer formed with the patterns for composing one identifying mark and the other identifying mark and the patterns of the resist layer formed with the patterns for composing one identifying mark and the other identifying mark can be used for a plurality of identifying marks.

When different identifying marks are formed, it can be coped with shielding a part of unnecessary identifying marks with the shielding portions, without changing patterns on the conductor layer and the patterns on the resist layer.

As a result, a plate, which is used for forming patterns composing an identifying mark on the conductor layer of the print-circuit board, and a plate which is used for forming patterns composing an identifying mark on the resist layer of the print-circuit board do not have to be adjusted for each identifying mark.

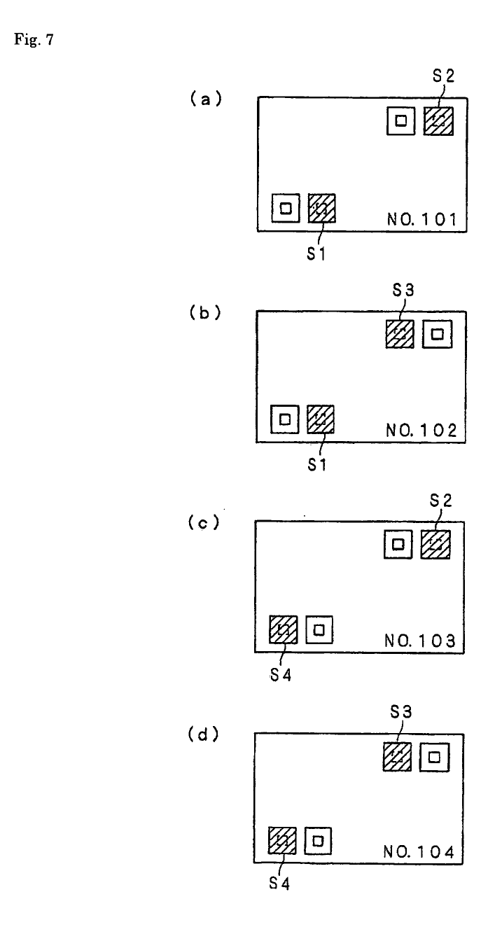

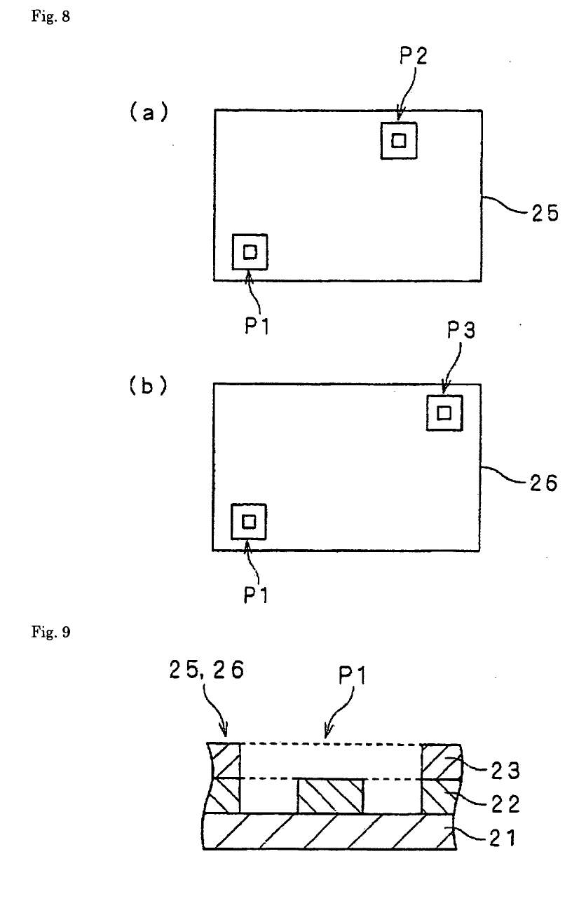

FIGS. 7A to 7D show examples of the print-circuit board formed by the third embodiment of the present invention. In the examples shown in FIGS. 7A to 7D, not only the shielding portions but also numbers (NO.) of the print-circuit boards are printed on the print-circuit boards.

The shielding portions S1 and S2 and “NO. 101” are printed on the print-circuit board shown in FIG. 7A. The shielding portions S1 and S3 and “No. 102” are printed on the print-circuit board shown in FIG. 7B. The shielding portions S2 and S4 and “NO. 103” are printed on the print-circuit board shown in FIG. 7C. The shielding portions S3 and S4 and “NO. 104” are printed on the print-circuit board shown in FIG. 7D.

The numbers to be printed on the print-circuit boards can be formed by the same material as that of the shielding portions. When the shielding portions are printed by using the silk material, the numbers can be printed by using the silk material. The transfer plate for forming the shielding portions can be used for printing the numbers on the print-circuit boards.

The above explanation referred to the example using the silk material as the shielding material for forming the shielding portions, but materials other than the silk material can be used for the shielding material. That is to say, any shielding material may be used as long as it can shield patterns composing the other identifying mark formed on the print-circuit board and can shield the patterns in such a manner that the material is printed on the patterns composing the other identifying mark.

1. A print-circuit board forming method, the print-circuit board having an insulating substrate layer, a conductor layer and a resist layer, the conductor layer being laminated on the insulating substrate layer, the resist layer being laminated on the conductor layer, the print-circuit board having identifying marks for identifying the print-circuit board formed by patterns formed on the conductor layer and patterns formed on the resist layer, the method comprising:
the first step of forming the patterns for forming an identifying mark on the conductor layer; and
the second step of forming patterns for forming an identifying mark on the resist layer,
wherein the patterns for forming one identifying mark are formed on the conductor layer at the first step, and the patterns for forming one identifying mark and the patterns for forming the other identifying mark are formed on the resist layer at the second step,
when the patterns for forming the other identifying mark are formed on the resist layer at the second step, the other identifying mark is formed in a manner that its position corresponds to a predetermined position of the patterns to be formed on the conductor layer,
the patterns for composing one identifying mark to be formed on the conductor layer at the first step and the patterns for composing one identifying mark to be formed on the resist layer at the second step are formed in a manner that their positions correspond to a predetermined position on a plane of the print-circuit board, so that one identifying mark is formed.

2. A print-circuit board forming method, the print-circuit board having an insulating substrate layer, a conductor layer and a resist layer, the conductor layer being laminated on the insulating substrate layer, the resist layer being laminated on the conductor layer, the print-circuit board having identifying marks for identifying the print-circuit board formed by patterns formed on the conductor layer and patterns formed on the resist layer, the method comprising:
the first step of forming the patterns for forming an identifying mark on the conductor layer; and
the second step of forming patterns for forming an identifying mark on the resist layer,
wherein the patterns for forming one identifying mark and the patterns for forming the other identifying mark are formed on the conductor layer at the first step, and the patterns for forming one identifying mark are formed on the resist layer at the second step,
when the patterns for forming the other identifying mark are formed on the conductor layer at the first step, the other identifying mark is formed in a manner that its position corresponds to a predetermined position of the patterns formed on the resist layer,
the patterns for composing one identifying mark to be formed on the conductor layer at the first step and the patterns for composing one identifying mark to be formed on the resist layer at the second step are formed in a manner that their positions correspond to a predetermined position on a plane of the print-circuit board, so that one identifying mark is formed.

3. A print-circuit board forming method, the print-circuit board having an insulating substrate layer, a conductor layer and a resist layer, the conductor layer being laminated on the insulating substrate layer, the resist layer being laminated on the conductor layer, the print-circuit board having identifying marks for identifying the print-circuit board formed by patterns formed on the conductor layer and patterns formed on the resist layer, the method comprising:
the first step of forming the patterns for forming an identifying mark on the conductor layer; and
the second step of forming the patterns for forming an identifying mark on the resist layer,
wherein the patterns for forming one identifying mark and patterns for forming the other identifying mark are formed on the conductor layer at the first step, and the patterns for forming one identifying mark and the patterns for forming the other identifying mark are formed on the resist layer at the second step,
the patterns for composing one identifying mark to be formed on the conductor layer at the first step and the patterns for composing one identifying mark to be formed on the resist layer at the second step are formed in a manner that their positions correspond to a predetermined position on a plane of the print-circuit board, so that one identifying mark is formed,
the patterns for composing the other identifying mark to be formed on the conductor layer at the first step and the patterns for composing the other identifying mark to be formed on the resist layer at the second step are formed in a manner that their positions correspond to a predetermined position on a plane of the print-circuit board, and
the print-circuit board forming method further comprising the third step of printing a shielding material on portions of the patterns for composing the other identifying mark on the conductor layer and the resist layer so as to shield the other identifying mark.

4. A print-circuit board which has an insulating substrate layer, a conductor layer and a resist layer and is constituted so that the conductor layer is laminated on the insulating substrate layer and the resist layer is laminated on the conductor layer, wherein:
the print-circuit board has identifying marks for identifying the print-circuit board formed by patterns formed on the conductor layer and patterns formed on the resist layer,
the patterns for forming one identifying mark are formed on the conductor layer,
the patterns for forming one identifying mark and the patterns for forming the other identifying mark are formed on the resist layer,
the patterns for forming the other identifying mark to be formed on the resist layer are formed in a manner that their position corresponds to a predetermined position of the patterns on the conductor layer,
the patterns for composing one identifying mark formed on the conductor layer and the patterns for composing one identifying mark formed on the resist layer are formed in a manner that their positions correspond to a predetermined position on a plane of the print-circuit board, so that one identifying mark is formed.

5. A print-circuit board which has an insulating substrate layer, a conductor layer and a resist layer and is constituted so that the conductor layer is laminated on the insulating substrate layer and the resist layer is laminated on the conductor layer, wherein:
the print-circuit board has identifying marks for identifying the print-circuit board formed by patterns formed on the conductor layer and patterns formed on the resist layer,
the patterns for forming one identifying mark and the patterns for forming the other identifying mark are formed on the conductor layer,
the patterns for forming one identifying mark are formed on the resist layer,
the patterns for forming the other identifying mark to be formed on the conductor layer are formed in a manner that their position correspond to a predetermined position of the patterns on the resist layer,
the patterns for composing one identifying mark formed on the conductor layer and the patterns for composing one identifying mark formed on the resist layer are formed in a manner that their positions correspond to a predetermined position on a plane of the print-circuit board, so that one identifying mark is formed.

6. A print-circuit board which has an insulating substrate layer, a conductor layer and a resist layer and is constituted so that the conductor layer is laminated on the insulating substrate layer and the resist layer is laminated on the conductor layer, wherein:
the print-circuit board has identifying marks for identifying the print-circuit board formed by patterns formed on the conductor layer and patterns formed on the resist layer,
the patterns for forming one identifying mark and the patterns for forming the other identifying mark are formed on the conductor layer,
the patterns for forming one identifying mark and patterns for forming the other identifying mark are formed on the resist layer,
the patterns for composing one identifying mark formed on the conductor layer and the patterns for composing one identifying mark formed on the resist layer are formed in a manner that their positions correspond to a predetermined position on a plane of the print-circuit board, so that one identifying mark is formed,
the patterns for composing the other identifying mark formed on the conductor layer and the patterns for composing the other identifying mark formed on the resist layer are formed in a manner that their positions correspond to a predetermined position on the plane of the print-circuit board, and
a portion of the patterns for composing the other identifying mark on the conductor layer and a portion of the patterns for composing the other identifying mark on the resist layer are shielded by shielding portions which are formed by printing a shielding material on the portions.
